(19) United States
(12) Patent Application Publication
(10) Pub. No.: US 2010/0296814 A1
(43) Pub. Date: Nov. 25, 2010

(54) METHOD AND DEVICE FOR OPTICAL DATA TRANSMISSION

(76) Inventors: RAIMUND PAMMER, Graz (AT); Wolgang Boh, Graz (AT); Andreas Schalk, Graz (AT); Helmut Rieder, Graz (AT)

Correspondence Address: BACON & THOMAS, PLLC, 625 SLATERS LANE, FOURTH FLOOR, ALEXANDRIA, VA, 22314-1176, US

(21) Appl. No.: 12/487,188

(22) Filed: Jun. 18, 2009

Related U.S. Application Data
(63) Continuation of application No. 10/515,171, filed on Oct. 27, 2005, now abandoned.
Application No. 10/515,171 is a continuation of application No. PCT/EP03/05425, filed on May 23, 2003.

(30) Foreign Application Priority Data
May 25, 2002 (DE) 102 23 376.4

(51) Int. Cl. H04J 14/08; H04B 10/00

(52) U.S. Cl. 398/99; 398/115

(57) ABSTRACT

The invention relates to a method and device for optical data transmission, in particular a method for transmission of data by means of digitised infrared signals. Data sequences are transmitted using a time-division multiplex access protocol with communication frames comprising single sequential windows with a given minimal bit transmission rate. At least one control impulse sequence is provided in each communication frame. According to the invention, the control impulse sequence is transmitted at a bit transmission rate which is lower than the minimum bit Transmission rate for the data sequence.

This application is a continuation of U.S. patent application Ser. No. 10/515,171, filed Oct. 27, 2005, which is a continuation of PCT Application Ser. No. PCT/EP03/05425, filed May 23, 2003.

### BACKGROUND OF THE INVENTION

1. Field of the Invention

The present invention relates to a method and a device for optical data transmission, in particular a method for transmitting data over at least one optical transmission route, in which data sequences are transmitted via a time division multiple access protocol, inside communication frames that comprise individual sequential windows, at a predetermined minimal bit transmission rate, and within each communication frame, at least one control pulse sequence is provided. The invention pertains above all to a method for wireless optical data transmission by means of digitized infrared signals.

2. Related Art

Modern wireless data transmission systems at present usually use digital technologies, which have experienced a great increase in development in recent years because of the increasingly popular mobile radio systems. In radio frequency and microwave transmission systems, digital technology has become established especially because the available bandwidth can be better utilized with higher data transmission quality, or in other words, especially in the mobile radio field, higher speech quality, over greater distances, with less mean transmission power. If a transmission route is to be used by multiple participants, then the participants compete for the use of this transmission route. Unless access of multiple participants is further regulated, collisions can therefore occur, which are extremely unwanted if secure, reliable transmission is to be attained. For regulating access to the physical resources of a transmission system, for instance to an individual transmission channel, special multiple access methods have been developed, which are also called medium access control (MAC). In the radio frequency field, two dominant systems have become established, which regulate how a number of participants receive interference-free access to a single transmission channel. These are on the one hand what is known as code division multiple access (CDMA) and on the other, time division multiple access (TDMA). The TDMA method is especially well known because it has been implemented in the European GSM mobile phone standard.

Recently, optical transmission systems, especially infrared transmission systems, have increasingly gained in significance. They are distinguished by simple, economic circuits and are not subject to national regulation, and because of their short wavelength, they do not exhibit what is known as Rayleigh fading.

For wireless infrared transmission systems, the TDMA method has become established for regulating multiple access by multiple participants. In it, each user of a single channel is assigned unambiguous time segments or time slots, known as windows. By the TDMA protocol, the data sequences or data bursts to be transmitted are disposed inside communication frames that are made up of individual sequential or in other words successive windows. Within each TDMA communication frame, not only the data sequences but also control pulse sequences (synchronization bursts) are provided.

In the simplest case, the TDMA communication frame comprises at least one control pulse sequence and at least one data window. Usually, the frame, after an introductory control sequence, begins with a detection window, which enables the individual participants to be assigned a time slot for their private communication. An organization window can follow, which describes the subsequent time sequence in the TDMA frame by means of a so-called frame organization table (FOT). Finally, one or more windows for a—usually bidirectional—private data transmission follow, which each participant, for instance in a master/slave configuration, can use with his own special communications parameters, independently of other participants. Each window is introduced by a control pulse sequence. Control pulses can also occur within a window.

Conventionally, both data pulse sequences and control pulse sequences are transmitted at a predetermined minimal bit transmission rate. This puts a considerable burden on the processor provided for the data acquisition and evaluation, since the processor must continuously monitor the incoming data stream for the occurrence of control pulse sequences. Moreover, it is complicated to integrate a plurality of data sequences from communications participants who are working at different bit transmission rates and/or with different types of modulation, within a single communication frame.

### BRIEF SUMMARY OF THE INVENTION

The object of the present invention is therefore to furnish a method and a device for transmitting data over at least one optical transmission route which relieve the burden on the processor in evaluating the data stream and enable simultaneous utilization of the same transmission channel by variously powerful communications participants.

This object is attained by the method of present claim 1 and by the device of present claim 8. Further advantageous refinements of the invention are the subjects of the dependent claims.

The subject of the present invention is accordingly, first, a method for transmitting data over at least one optical transmission route, in which the data sequences are transmitted via a time division multiple access protocol, inside communication frames that comprise individual sequential windows, at a predetermined minimal bit transmission rate, and within each communication frame, at least one control pulse sequence is provided, and the method is characterized in that the control pulse sequence is transmitted at a bit transmission rate that is lower than the minimal bit transmission rate of the data sequences.

With the method of the invention, it is possible to implement the detection of control pulse sequences by hardware, for instance by means of a gate circuit, so that the processor is relieved and is primarily available for data evaluation and further processing of the data.

Advantageously, the control pulse sequence is transmitted at a bit transmission rate that is less than 80% and preferably less than 65% of the minimal bit transmission rate of the data sequences. Especially preferably, the control pulse sequence is transmitted at a bit transmission rate that is approximately 50% of the minimal bit transmission rate of the data sequences.

Within one communication frame, different control pulse sequences can occur, which are preferably characterized by different lengths, that is, by a different total duration.

Each communication frame advantageously includes a control pulse sequence for frame synchronization. This is especially preferable whenever, over the course of time, various and in particular new participants want to transmit data. In a transmission system made up of only two specific participants, frame synchronization can be done only once, the first time the connection is made, or each time a new connection is made. Subsequent communication frames then require no introductory synchronization.

Besides the frame synchronization, preferably control pulse sequences for window synchronization and so-called “command alerts”, that is, control pulse sequences for introducing commands, are also provided. Preferably, the control pulse sequences have a hierarchical structure, so that a higher-ranking control pulse sequence includes a lower-ranking control pulse sequence. Thus preferably a frame synchronization sequence is embodied such that it also includes a window synchronization sequence and the “command alert” sequence, while the window synchronization sequence includes at least the “command alert” sequence.

As the optical transmission route, especially preferably an infrared transmission route is used, which advantageously operates at one or more standardized wavelengths, such as 850 nm.

A particular advantage of the method of the invention is considered to be that the data transmitted in the sequential windows may have different bit transmission rates and/or different types of modulation.

The subject of the present invention is furthermore a device for transmitting data over at least one optical transmission route. The device of the invention includes at least two participants, in which each participant has electrooptical data transmission means, with means for generating data sequences and control pulse sequences, and evaluation means, having at least one processor for data processing. The device of the invention is characterized in that the means for generating data sequences and control pulse sequences are embodied such that the control pulse sequences are generated at a lower bit transmission rate than the data sequences; and that the evaluation means furthermore have means, preceding the processor, for detecting control pulse sequences.

A particular advantage of the method of the invention is due to its simple implementation by hardware. The means for detecting control pulse sequences can for instance be embodied as a simple gate circuit. The gate is switched in such a way that if a control pulse sequence at a low bit transmission rate is detected at the gate, an interrupt is sent to the processor. The very great majority of the processor power of a participant is therefore available, as already mentioned above, for data evaluation, since continuous monitoring of the data stream by the processor for the occurrence of control pulse sequences is not necessary. After an interrupt has arrived, the processor need merely interrupt its instantaneous data processing to execute the command sequence arriving in the data stream.

Preferably, the data transmission means of the device of the invention include at least one infrared transmitter, such as an IR diode or an IR laser, and at least one infrared receiver, such as an IR-sensitive photodiode.

The present invention also makes it possible for communications participants to transmit data within the same communication frame at a different transmission rate and with different types of modulation. For instance, participants that work with 1 Megabit and 100 Megabits can, independently of one another and without interference from one another, use windows for private data transmission within the same communication frame.

### DESCRIPTION OF THE DRAWINGS

The invention will be described in further detail below in terms of a preferred exemplary embodiment shown in the accompanying drawings.

In the drawings:

FIG. 1 schematically shows a transmission system of the invention, with three participants;

FIG. 2 shows a communication frame, used in the method of the invention, for data transmission; and

FIG. 3 shows typical control pulse sequences used in the communication frame of FIG. 2.

### DETAILED DESCRIPTION OF THE PREFERRED EMBODIMENTS OF THE INVENTION

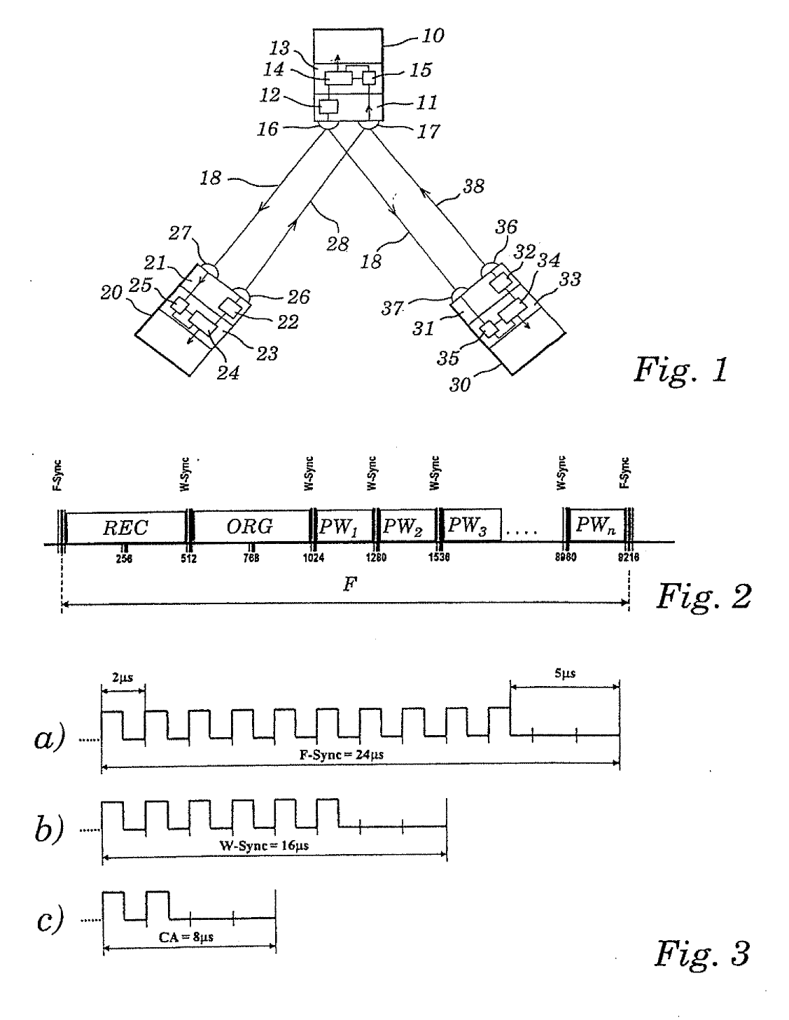

With reference to FIG. 1, an infrared transmission system comprising three participants 10, 20, 30 can be seen. Each participant 10, 20, 30 has electrooptical data transmission means 11, 21, 31 and evaluation means 13, 23, 33. The data transmission means include pulse generators 12, 22, 32 for generating data pulse sequences and control pulse sequences, of the kind shown in more detail in FIGS. 2 and 3. In them, control pulse sequences are generated at a lower bit transmission rate than the data sequences. The sequences thus generated are emitted in form of infrared light pulses 18, 28, 38 via infrared transmitters 16, 26, and are detected by the respective counterpart participants via infrared receivers 17, 27, 37. The data, converted into electrical signals by the infrared receivers 17, 27, 37, are carried via a gate circuit 15, 25, 35 to a processor 14, 24, 34 of the evaluation device 13, 23, 33 and from there on to further memory or display devices (not shown), each merely symbolized by an arrow.

The digitized data stream, transmitted over the infrared transmission route, is subdivided into successive TDMA communication frames F. In FIG. 2, a typical frame F that can be used in the method of the invention is shown schematically. The TDMA communication frame F comprises a recognition window REC, for making the connection and for synchronization among various participants. In the ensuing organization window ORG, the following time sequence and the association of the ensuing window PWₙ for private data transmission among the individual participants is defined by means of a so-called frame organization table FOT. In the data transmission window PWₙ, a usually bidirectional private data transmission takes place, which each participant can use, for instance in a master/slave configuration or a peer-to-peer configuration, with his own special communications parameters, independently of other participants. Each window is introduced by a control pulse sequence. Each data window, REC, ORG, or PWₙ, comprises a number of time increments, each 256 μs in duration, and the maximum frame length in this example is 65.28 ms, equivalent to a maximum of 256 individual window increments.

One essential aspect of the invention is that the bit transmission rate of the data sequences in the data windows REC, ORG and PWₙ is effected at as high as possible a transmission rate for the particular participant, which is equal to or greater than a predetermined minimal bit transmission rate f₁, for instance of 1 MHz, and for powerful participants can therefore amount to 10 or 100 MHz, for instance. Variously powerful participants can transmit and receive within the same frame F. For instance, one participant, in his private data window PW₁ assigned to him, can transmit and receive a 100 MHz data sequence modulated in a particular way, while another participant, in his private data window PW₂ assigned to him, transmits and/or receives at only a transmission rate of 1 MHz.

Conversely, the control pulse sequences are transmitted at a lower bit transmission rate f₂. Typical examples of unmodulated control pulse sequences are shown in FIG. 3. In the example shown, each control pulse sequence has a transmission rate f₂ of 500 kHz, with a duty cycle of 0.5, and is terminated with an OFF time of 5 μs. The transmission rate of the control pulse sequences is accordingly 50% of the data transmission rate. The three control pulse sequences shown differ from one another in having a different length (total duration). The introductory control pulse sequence for synchronizing the communication frame F-Sync, shown in FIG. 3 a), for instance has a total duration of 24 μm, while the control pulse sequence W-Sync, used inside the communication frame for synchronizing the individual windows and shown in FIG. 3 b), has a total duration of 16 μm. Within each window (that is, REC, ORG, and PWₙ in FIG. 2), brief control pulse sequences CA (for instance, 8 μm long) can occur, as shown in FIG. 3 c), which tell the system that the next higher-frequency data byte, or the next two data bytes, are to be interpreted as a command and are therefore called commando alerts.

It can be seen that the structure of the three control pulse sequences is selected to be hierarchical, so that one F-Sync always also includes a W-Sync and a CA; that is, an F-Sync introduces a new window, and the first data byte (or the first two data bytes) are interpreted as commands.

The frame and window synchronization scheme of the present invention may be employed in various wireless IR communications systems. However, it is especially suitable for implementation in systems for transportation information and transport control, such as systems for wireless detection of road use fees (tolls). For instance, the synchronization method of the invention can be implemented within the context of the planned “communication air interface at long and medium range” (CALM-IR, ISO/AWI 21214) standards, which specify specifications for master/slave and peer-to-peer data transmission at 850 nm.

1. A method for transmitting data over at least one optical transmission route, comprising
data sequences are transmitted via a time division multiple access protocol, inside communication frames that comprise individual sequential windows, at a predetermined minimal bit transmission rate,
within each communication frame, at least one control pulse sequence is provided, said control pulse sequence being transmitted at a bit transmission rate that is lower than the minimal bit transmission rate of the data sequences,
and said control pulse sequences is detected and the processing of said data sequences is controlled as a function of the control pulse sequence detected.

2. The method of claim 1, wherein said control pulse sequence is transmitted at a bit transmission rate that is less than 80% and preferably less than 65% of the minimal bit transmission rate of said data sequences.

3. The method of claim 2, wherein said control pulse sequence is transmitted at a bit transmission rate that is approximately 50% of the minimal bit transmission rate of said data sequences.

4. The method of claim 1, wherein different control pulse sequences are used, said different control pulse sequences being characterized by different lengths.

5. The method of claim 1, wherein said communication frame comprises a control pulse sequence for frame synchronization.

6. The method of claim 1, wherein said optical transmission route is an infrared transmission route.

7. The method of claim 1, wherein said data sequences transmitted in the sequential windows have either or both different bit transmission rates and/or different types of modulation.

8. A device for transmitting data over at least one optical transmission route, having at least two participants, wherein each participant has electrooptical data transmission means said data transmission means comprising means for generating data sequences and control pulse sequences, and evaluation means, having at least one processor for data processing, wherein
said means for generating data sequences and control pulse sequences are arranged such that the control pulse sequences are generated at a lower bit transmission rate than the data sequences; and
said evaluation means includes a device, preceding the processor, for detecting control pulse sequences.

9. The device of claim 8, wherein said data transmission means include at least one infrared transmitter and at least one infrared receiver.

10. The device of claim 8, wherein said data sequences transmitted by the participant have different bit transmission rates and/or different types of modulation.
